(19) United States
(12) Patent Application Publication
(10) Pub. No.: US 2023/0318500 A1
(43) Pub. Date: Oct. 5, 2023

(54) MOTOR-DRIVEN COMPRESSOR

(71) Applicant: KABUSHIKI KAISHA TOYOTA JIDOSHOKKI, Kariya-shi (JP)

(72) Inventors: Keita TATEMATSU, Kariya-shi (JP); Takashi Kawashima, Kariya-shi (JP); Takuya Naruse, Kariya-shi (JP)

(73) Assignee: KABUSHIKI KAISHA TOYOTA JIDOSHOKKI, Kariya-shi (JP)

(21) Appl. No.: 18/128,086

(22) Filed: Mar. 29, 2023

(30) Foreign Application Priority Data
Mar. 31, 2022 (JP) 2022-060599

(51) Int. Cl. H02P 21/36; H02P 21/22; F25B 31/02

(52) U.S. Cl. CPC H02P 21/36; H02P 21/22; F25B 31/02; H02P 2207/05

(57) ABSTRACT

A controller uses a differential pressure between a discharge pressure and a suction pressure to estimate an execution time of braking control needed to fix a position of a rotor at a specific angle. Further, the controller executes the braking control by the estimated execution time. This prevents the controller from unnecessarily continuing to execute the braking control.

### BACKGROUND

### 1. Field

The present disclosure relates to a motor-driven compressor.

### 2. Description of Related Art

The motor-driven compressor includes a compression portion, a motor, and an inverter. The compression portion includes a compression chamber. The compression chamber compresses and discharges drawn fluid. The motor drives the compression portion. The inverter includes switching elements. The switching elements perform switching operations to drive the motor. The motor-driven compressor further includes a controller. The controller controls the driving of the motor. When the switching elements perform switching operations, the direct-current voltage from an external power supply is converted into alternating-current voltage. The alternating-current voltage is applied to the motor as drive voltage. As a result, the driving of the motor is controlled. Upon receipt of a stop command for the motor, the controller stops the switching operations performed by the switching elements. Consequently, the driving of the motor stops.

When the controller stops the switching operations performed by the switching elements, the rotor of the motor rotates idly and then stops rotating. In the motor-driven compressor, as the fluid that remains in the compression chamber expands, the rotor that stopped rotating may start rotating backwards. Backward rotation of the rotor causes the compression portion to produce noise. To prevent the rotor from rotating backwards, the controller receives the stop command for the motor and then executes braking control that controls the switching operations performed by the switching elements to fix the position of the rotor at a specific angle. Japanese Laid-Open Patent Publication No. 2000-287485 discloses an example of executing direct-current exciting energization or zero vector energization as the braking control.

In such a motor-driven compressor, it is desired that the backward rotation of the rotor be efficiently prevented.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

To solve the above problem, a first aspect of the present disclosure provides a motor-driven compressor that includes: a compression portion including a compression chamber that compresses and discharges drawn fluid; a motor that drives the compression portion; an inverter including a switching element that performs switching operation to drive the motor; a controller that controls the driving of the motor, the controller being configured to receive a stop command for the motor and then execute braking control that controls the switching operation performed by the switching element such that a position of a rotor of the motor is fixed at a specific angle; and a time estimation unit that uses a differential pressure between a discharge pressure and a suction pressure to estimate an execution time of the braking control needed to fix the position of the rotor at the specific angle. The controller is configured to execute the braking control for the execution time estimated by the time estimation unit.

Other features and aspects will be apparent from the following detailed description, the drawings, and the claims.

### BRIEF DESCRIPTION OF DRAWINGS

FIG. 1 is a cross-sectional view of a motor-driven compressor according to an embodiment.

FIG. 2 is a circuit diagram showing the electrical configuration of the motor-driven compressor.

FIG. 3 is a timing diagram showing changes in the q-axis current, the discharge pressure, the pressure in the compression chamber, the suction pressure, and the rotation speed of the motor.

FIG. 4 is a flowchart illustrating the control performed by the controller.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

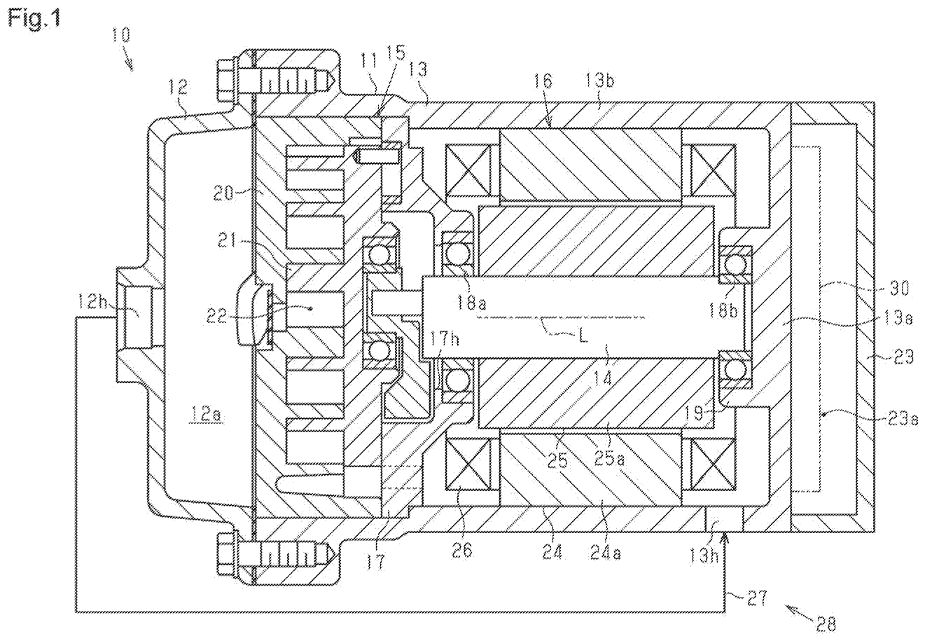

A motor-driven compressor 10 according to an embodiment will now be described with reference to FIGS. 1 to 4. The motor-driven compressor 10 of the present embodiment is employed in, for example, a vehicle air conditioner 28.

Basic Structure of Motor-Driven Compressor 10

As shown in FIG. 1, the motor-driven compressor 10 includes a housing 11. The housing 11 includes a discharge housing member 12 and a motor housing member 13. The discharge housing member 12 and the motor housing member 13 are made of metal. The discharge housing member 12 and the motor housing member 13 are made of, for example, aluminum. The discharge housing member 12 is tubular. The motor housing member 13 includes a plate-shaped end wall 13a and a tubular circumferential wall 13b. The circumferential wall 13b extends from an outer circumferential portion of the end wall 13a.

The motor-driven compressor 10 includes a rotary shaft 14. The rotary shaft 14 is accommodated in the motor housing member 13. The motor-driven compressor 10 includes a compression portion 15 and a motor 16. The compression portion 15 and the motor 16 are accommodated in the motor housing member 13. Rotation of the rotary shaft 14 drives the compression portion 15. The compression portion 15 compresses refrigerant (fluid). The motor 16 rotates the rotary shaft 14 to drive the compression portion 15. The compression portion 15 and the motor 16 are arranged in the axial direction of the rotary shaft 14, in which a rotational axis L of the rotary shaft 14 extends. The motor 16 is located closer to the end wall 13a than the compression portion 15.

The motor-driven compressor 10 includes a shaft support 17. In the motor housing member 13, the shaft support 17 is located between the compression portion 15 and the motor 16. The shaft support 17 has an insertion hole 17h. The insertion hole 17h is located at a middle portion of the shaft support 17. A first end of the rotary shaft 14 is inserted through the insertion hole 17h. A bearing 18a is arranged between the insertion hole 17h and the first end of the rotary shaft 14. The first end of the rotary shaft 14 is rotationally supported by the shaft support 17 with the bearing 18a.

The motor housing member 13 includes a tubular bearing portion 19. The bearing portion 19 protrudes from a middle portion of the end wall 13a of the motor housing member 13. A second end of the rotary shaft 14 is inserted into the bearing portion 19. A bearing 18b is arranged between the bearing portion 19 and the second end of the rotary shaft 14. The second end of the rotary shaft 14 is rotationally supported by the bearing portion 19 with the bearing 18b.

The compression portion 15 includes a fixed scroll 20 and an orbiting scroll 21. The fixed scroll 20 is fixed on an inner circumferential surface of the circumferential wall 13b of the motor housing member 13. The orbiting scroll 21 faces the fixed scroll 20. The fixed scroll 20 meshes with the orbiting scroll 21. A compression chamber 22, the volume of which is variable, is defined between the fixed scroll 20 and the orbiting scroll 21. The compression chamber 22 compresses and discharges drawn refrigerant. Thus, the compression portion 15 includes the compression chamber 22, which compresses and discharges drawn refrigerant.

The motor 16 includes a tubular stator 24 and a tubular rotor 25. The rotor 25 is located in the stator 24. The rotor 25 rotates integrally with the rotary shaft 14. The stator 24 surrounds the rotor 25. The rotor 25 includes a rotor core 25a fixed to the rotary shaft 14 and permanent magnets (not shown) arranged on the rotor core 25a. The stator 24 includes a tubular stator core 24a and a coil 26 wound around the stator core 24a. When power is supplied to the coil 26, the rotor 25 and the rotary shaft 14 rotate.

The motor-driven compressor 10 includes an inverter 30. The motor-driven compressor 10 includes a tubular cover 23. The cover 23 is attached to the end wall 13a of the motor housing member 13. The end wall 13a of the motor housing member 13 and the cover 23 define an inverter chamber 23a. The inverter 30 is accommodated in the inverter chamber 23a. The compression portion 15, the motor 16, and the inverter 30 are arranged in this order in the axial direction of the rotary shaft 14.

The motor housing member 13 has a suction port 13h. The suction port 13h is located in the circumferential wall 13b. Refrigerant is drawn from the suction port 13h into the motor housing member 13. A first end of an external refrigerant circuit 27 is connected to the suction port 13h. The motor-driven compressor 10 includes a discharge chamber 12a. The discharge chamber 12a is defined in the discharge housing member 12. The discharge housing member 12 has a discharge port 12h. The discharge port 12h connects to the discharge chamber 12a. A second end of the external refrigerant circuit 27 is connected to the discharge port 12h.

Refrigerant is drawn from the external refrigerant circuit 27 into the motor housing member 13 through the suction port 13h. Thus, the inside of the motor housing member 13 is a suction pressure region. The refrigerant drawn into the motor housing member 13 is drawn into the compression chamber 22 by the orbiting of the orbiting scroll 21. The refrigerant in the compression chamber 22 is compressed by the orbiting of the orbiting scroll 21. The refrigerant compressed in the compression chamber 22 is discharged to the discharge chamber 12a. Thus, the discharge chamber 12a is a discharge pressure region. The refrigerant discharged to the discharge chamber 12a flows through the discharge port 12h into the external refrigerant circuit 27. The refrigerant that has flowed to the external refrigerant circuit 27 flows through a heat exchanger or an expansion valve of the external refrigerant circuit 27. Then, the refrigerant flows through the suction port 13h and returns to the motor housing member 13. The motor-driven compressor 10 and the external refrigerant circuit 27 are included in the vehicle air conditioner 28.

Electrical Configuration of Motor-Driven Compressor 10

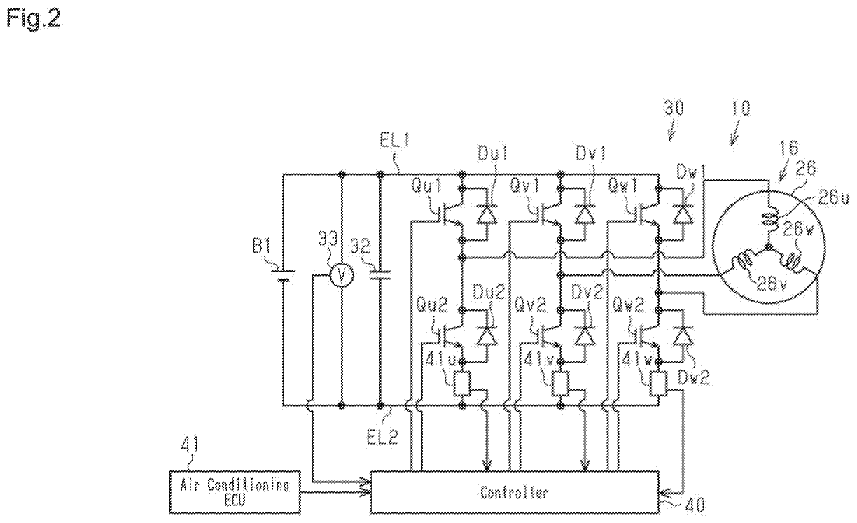

As shown in FIG. 2, the coil 26 of the motor 16 has a three-phase structure with a u-phase coil 26u, a v-phase coil 26v, and a w-phase coil 26w. In the present embodiment, the u-phase coil 26u, the v-phase coil 26v, and the w-phase coil 26w form a Y-connection.

The inverter 30 includes a positive electrode line EL1 and a negative electrode line EL2. The positive electrode line EL1 is electrically connected to the positive electrode of a battery B1. The negative electrode line EL2 is electrically connected to the negative electrode of the battery B1. The battery B1 is a power supply that supplies power to a device mounted on a vehicle. The battery B1 is a direct-current power supply. The battery B1 is, for example, a rechargeable battery or a capacitor.

The inverter 30 includes switching elements Qu1, Qu2, Qv1, Qv2, Qw1, Qw2. The switching elements Qu1, Qu2, Qv1, Qv2, Qw1, Qw2 perform switching operations to drive the motor 16. The switching elements Qu1, Qu2, Qv1, Qv2, Qw1, Qw2 are, for example, power switching elements such as insulated gate bipolar transistors (IGBTs). Diodes Du1, Du2, Dv1, Dv2, Dw1, Dw2 are respectively connected to the switching elements Qu1, Qu2, Qv1, Qv2, Qw1, Qw2. The diodes Du1, Du2, Dv1, Dv2, Dw1, Dw2 are respectively connected in parallel to the switching elements Qu1, Qu2, Qv1, Qv2, Qw1, Qw2.

The switching elements Qu1, Qv1, Qw1 are included in the upper arm in their respective phases. The switching elements Qu1, Qv1, Qw1 included in the upper arm may be hereinafter referred to as upper arm switching elements Qu1, Qv1, Qw1. The switching elements Qu2, Qv2, Qw2 are included in the lower arm in their respective phases. The switching elements Qu2, Qv2, Qw2 included in the lower arm may be hereinafter referred to as lower arm switching elements Qu2, Qv2, Qw2. Thus, the switching elements Qu1, Qu2, Qv1, Qv2, Qw1, Qw2 include the upper arm switching elements Qu1, Qv1, Qw1 and the lower arm switching elements Qu2, Qv2, Qw2.

An emitter of the upper arm switching element Qu1 is connected in series to a collector of the lower switching element Qu2. The section between the upper arm switching element Qu1 and the lower switching element Qu2 is connected to the u-phase coil 26u. A collector of the upper arm switching element Qu1 is electrically connected to the positive electrode line EL1. An emitter of the lower switching element Qu2 is electrically connected to the negative electrode line EL2 via a current sensor 41u. The current sensor 41u detects a u-phase current Iu flowing through the motor 16.

An emitter of the upper arm switching element Qv1 is connected in series to a collector of the lower switching element Qv2. The section between the upper arm switching element Qv1 and the lower switching element Qv2 is connected to the v-phase coil 26v. A collector of the upper arm switching element Qv1 is electrically connected to the positive electrode line EL1. An emitter of the lower switching element Qv2 is electrically connected to the negative electrode line EL2 via a current sensor 41v. The current sensor 41v detects a v-phase current Iv flowing through the motor 16.

An emitter of the upper arm switching element Qw1 is connected in series to a collector of the lower switching element Qw2. The section between the upper arm switching element Qw1 and the lower switching element Qw2 is connected to the w-phase coil 26w. A collector of the upper arm switching element Qw1 is electrically connected to the positive electrode line EL1. An emitter of the lower switching element Qw2 is electrically connected to the negative electrode line EL2 via a current sensor 41w. The current sensor 41w detects a w-phase current Iw flowing through the motor 16.

The inverter 30 includes a capacitor 32. The capacitor 32 is, for example, a film capacitor or an electrolytic capacitor. The capacitor 32 is connected in parallel to the battery B1. The motor-driven compressor 10 includes a voltage sensor 33. The voltage sensor 33 detects an input voltage from the battery B1.

Controller 40

The motor-driven compressor 10 includes a controller 40. The controller 40 controls the switching operations of the switching elements Qu1, Qu2, Qv1, Qv2, Qw1, Qw2. The controller 40 includes, for example, one or more dedicated hardware circuit and/or one or more processors (control circuits) that run in accordance with a computer program (software). The processor includes a CPU and a memory (e.g., RAM and ROM). The memory stores program codes or commands configured to cause the processor to execute various processes. The memory, or computer readable medium, includes any type of medium that is accessible by general-purpose computers and dedicated computers. Further, the controller 40 includes a timer.

The controller 40 is electrically connected to an air conditioning electronic control unit (ECU) 41. The air conditioning ECU 41 controls the entire vehicle air conditioner 28. The air conditioning ECU 41 is capable of obtaining parameters, such as the temperature of the passenger compartment and a setting temperature. Based on these parameters, the air conditioning ECU 41 sends the information related to a target rotation speed of the motor 16 to the controller 40. Further, the air conditioning ECU 41 sends various commands (e.g., a running command for the motor 16 and a stop command for the motor 16) to the controller 40. The various commands from the air conditioning ECU 41 are received by the controller 40 from an external device.

Based on the commands from the air conditioning ECU 41, the controller 40 cyclically turns the switching elements Qu1, Qu2, Qv1, Qv2, Qw1, Qw2 on and off. Specifically, the controller 40 uses the commands from the air conditioning ECU 41 to execute pulse width modulation (PWM) control for the switching elements Qu1, Qu2, Qv1, Qv2, Qw1, Qw2. More specifically, the controller 40 uses a carrier signal and a command voltage value signal (signal for comparison) to generate control signals. Then, the controller 40 uses the generate control signals to execute on-off control for the switching elements Qu1, Qu2, Qv1, Qv2, Qw1, Qw2, thereby converting the direct-current power into alternating-current power. The alternating-current voltage obtained through the conversion is applied to the motor 16 as a drive voltage. As a result, the driving of the motor 16 is controlled. Thus, the controller 40 controls the driving of the motor 16.

The controller 40 is electrically connected to the voltage sensor 33. The controller 40 receives the information related to the input voltage from the battery B1 that has been detected by the voltage sensor 33. The controller 40 is electrically connected to the current sensors 41u, 41v, 41w. The controller 40 receives the information related to the u-phase current Iu, the v-phase current Iv, and the w-phase current Iw that flow through the motor 16 and have been respectively detected by the current sensors 41u, 41v, 41w.

The controller 40 estimates a position θ of the rotor 25 of the motor 16 based on the current flowing from the inverter 30 into the motor 16, without using a rotation angle sensor (e.g., a resolver) that detects the position θ of the rotor 25 of the motor 16. By estimating the position θ of the rotor 25, the controller 40 can control the driving of the motor 16. Thus, in the motor-driven compressor 10 of the present embodiment, the position θ of the rotor 25 estimated by the controller 40 is used to perform position sensorless control that controls rotation of the motor 16.

Specifically, the controller 40 stores a rotor position estimation program in advance. The rotor position estimation program estimates the position θ of the rotor 25 from the input voltage detected by the voltage sensor 33 and from the u-phase current Iu, the v-phase current Iv, and the w-phase current Iw, which flow through the motor 16 and have been respectively detected by the current sensors 41u, 41v, 41w. Thus, the controller 40 estimates the position θ of the rotor 25 based on the input voltage detected by the voltage sensor 33 and the u-phase current Iu, the v-phase current Iv, and the w-phase current Iw, which flow through the motor 16 and have been respectively detected by the current sensors 41u, 41v, 41w.

Based on the estimated position θ of the rotor 25, the controller 40 converts the u-phase current Iu, the v-phase current Iv, and the w-phase current Iw into a d-axis current, which is an excitation component current, and a q-axis current, which is a torque component current. The d-axis current is a current vector component in the same direction as the magnetic flux produced by permanent magnets in the current flowing through the motor 16. The q-axis current is a current vector component that is orthogonal to the d-axis in the current flowing through the motor 16. The controller 40 executes on-off control for the switching elements Qu1, Qu2, Qv1, Qv2, Qw1, Qw2 such that the d-axis current and the q-axis current each have a target value. Thus, the motor 16 rotates at a target rotation speed sent from the air conditioning ECU 41.

The controller 40 stores a program that executes a first speed reduction control, a program that executes a second speed reduction control, and a program that executes a braking control. Thus, the controller 40 executes the braking control.

First Speed Reduction Control

The first speed reduction control reduces the rotation speed of the motor 16, while also estimating the position θ of the rotor 25 of the motor 16 based on the current (u-phase current Iu, v-phase current Iv, and w-phase current Iw) flowing from the inverter 30 into the motor 16. Thus, the first speed reduction control reduces the rotation speed of the motor 16 through position sensorless control. The controller 40 stores, in advance, a program that executes the first speed reduction control by stopping the switching operations of the switching elements Qu1, Qu2, Qv1, Qv2, Qw1, Qw2 upon receipt of the stop command for the motor 16 from the air conditioning ECU 41.

Second Speed Reduction Control

The second speed reduction control reduces the rotation speed of the motor 16 to zero through forced synchronization control. Thus, the controller 40 reduces the rotation speed of the motor 16 to zero through forced synchronization control. Forced synchronization control reduces the rotation speed of the motor 16 by forcibly supplying current to the motor 16, without estimating the position θ of the rotor 25 like position sensorless control. The controller 40 stores, in advance, a program that switches the first speed reduction control to the second speed reduction control when the rotation speed of the motor 16 decreases to a predetermined rotation speed of the motor 16 after the rotation speed of the motor 16 is reduced through the first speed reduction control.

Braking Control

After receiving the stop command for the motor 16, the braking control controls the switching operations of the switching elements Qu1, Qu2, Qv1, Qv2, Qw1, Qw2 such that the position θ of the rotor 25 is fixed at a specific angle. The controller 40 stores, in advance, a program that executes direct-current exciting energization as the braking control. In the present embodiment, the controller 40 executes only direct-current exciting energization as the braking control. Direct-current exciting energization energizes, for example, the upper arm switching element Qu1 and the lower arm switching element Qv2. The controller 40 stores, in advance, a program that executes the braking control at a point in time when the rotation speed of the motor 16 becomes zero after the rotation speed of the motor 16 is reduced to zero through forced synchronization control. Thus, the controller 40 executes the braking control at the point in time when the rotation speed of the motor 16 becomes zero. In the present embodiment, since the rotation speed of the motor 16 is reduced to zero through forced synchronization control, the information indicating the point in time when the rotation speed of the motor 16 becomes zero can be obtained in advance by the controller 40.

Time Estimation Unit

The controller 40 stores, in advance, an execution time estimation program that estimates an execution time Tx of the braking control needed to fix the position θ of the rotor 25 at the specific angle. The controller 40 stores, in advance, an execution time calculation map used to calculate the execution time Tx by multiplying a coefficient (gain) by the value of the q-axis current obtained at a point in time when the stop command for the motor 16 is received from the air conditioning ECU 41. The execution time estimation program uses the execution time calculation map to estimate the execution time Tx. Thus, the controller 40 estimates the execution time Tx based on the q-axis current obtained at the point in time when the stop command for the motor 16 is received from the air conditioning ECU 41.

The coefficient multiplied by the value of the q-axis current is obtained in advance through experiments or the like based on the type and characteristics of the motor-driven compressor 10 in order to calculate the execution time Tx of the braking control, which is needed to fix the position θ of the rotor 25 at the specific angle. The coefficient multiplied by the value of the q-axis current may be a constant or may be a function that varies depending on the type and characteristics of the motor-driven compressor 10.

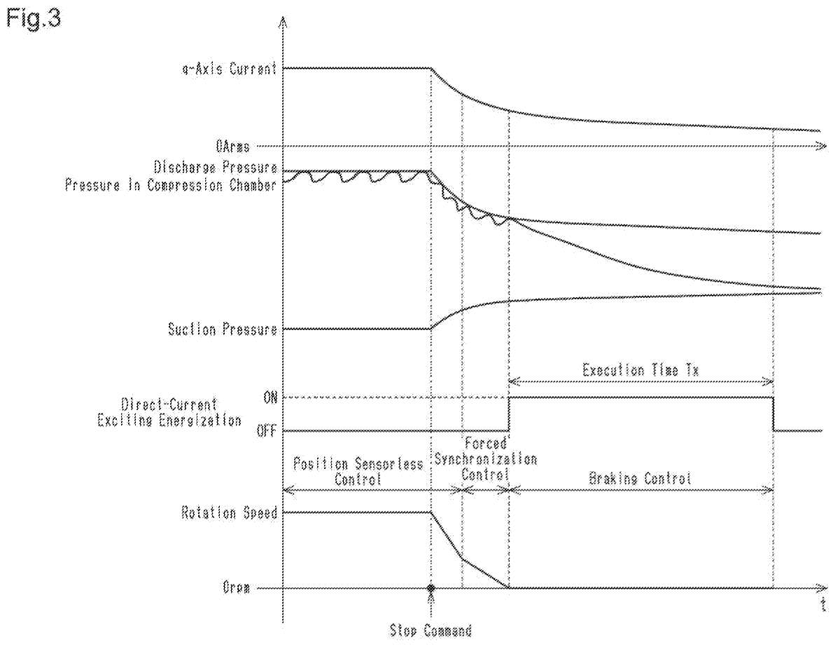

As shown in FIG. 3, the discharge pressure and the suction pressure are substantially constant when the motor-driven compressor 10 is running. The discharge pressure is the pressure of the refrigerant compressed in the compression chamber 22 and discharged to the discharge chamber 12a. Thus, the discharge pressure is the pressure in the discharge chamber 12a. The suction pressure is the pressure of refrigerant drawn into the compression chamber 22. Thus, the suction pressure is the pressure in the motor housing member 13.

Upon receipt of the stop command for the motor 16 from the air conditioning ECU 41, the controller 40 executes the first speed reduction control and the second speed reduction control in this order so that the discharge pressure gradually decreases as the rotation speed of the motor 16 gradually decreases. As the discharge pressure gradually decreases, the pressure in the compression chamber 22 also gradually decreases. In contrast, upon receipt of the stop command for the motor 16 from the air conditioning ECU 41, the controller 40 executes the first speed reduction control and the second speed reduction control in this order so that the suction pressure gradually increases as the rotation speed of the motor 16 gradually decreases.

When the motor-driven compressor 10 is running, the value of the q-axis current falls within a substantially constant range that varies depending on pressure pulsation in the compression chamber 22. Upon receipt of the stop command for the motor 16 from the air conditioning ECU 41, the controller 40 executes the first speed reduction control and the second speed reduction control in this order so that the value of the q-axis current gradually decreases as the rotation speed of the motor 16 gradually decreases. The changes in the value of the q-axis current follow the changes in the discharge pressure. Thus, the q-axis current flowing through the motor 16 is associated with the differential pressure between the discharge pressure and the suction pressure.

Thus, the controller 40 also estimates the execution time Tx of the braking control, which is needed to fix the position θ of the rotor 25 at the specific angle, based on the differential pressure between the discharge pressure and the suction pressure. Accordingly, the controller 40 functions as a time estimation unit that estimates the execution time Tx of the braking control, which is needed to fix the position θ of the rotor 25 at the specific angle, based on the differential pressure between the discharge pressure and the suction pressure. Hence, the motor-driven compressor 10 of the present embodiment includes the time estimation unit that estimates the execution time Tx of the braking control, which is needed to fix the position θ of the rotor 25 at the specific angle, based on the differential pressure between the discharge pressure and the suction pressure.

The controller 40 stores, in advance, a program that executes the braking control for the estimated execution time Tx. Thus, the controller 40 executes the braking control for the estimated execution time Tx. In the present embodiment, direct-current exciting energization is performed for the estimated execution time Tx. The controller 40 further stores, in advance a program that stops direct-current exciting energization when the execution time Tx elapses. The controller 40 measures the elapse of the execution time Tx using a timer.

Operation of Embodiment

The operation of the present embodiment will now be described.

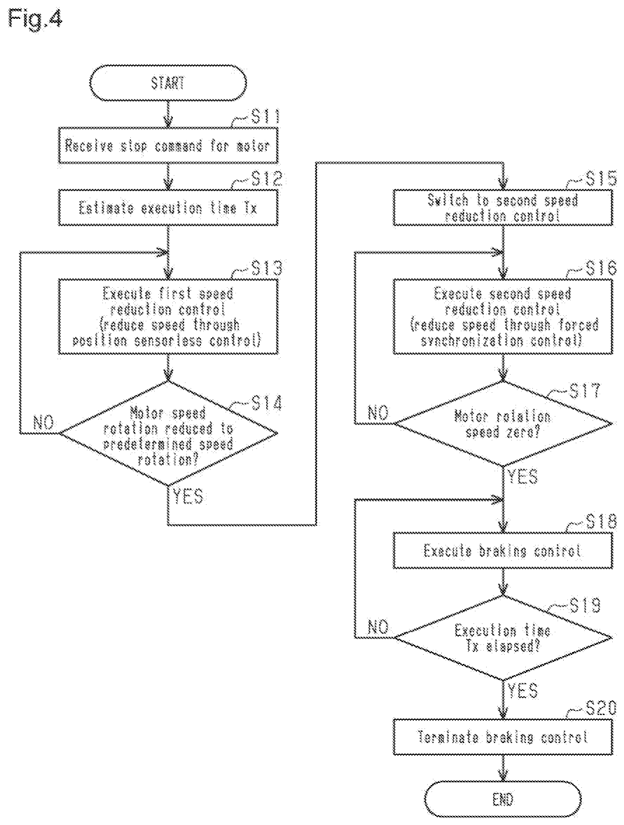

As shown in FIG. 4, in step S11, the controller 40 first receives the stop command for the motor 16 from the air conditioning ECU 41. Next, in step S12, upon receipt of the stop command for the motor 16 from the air conditioning ECU 41, the controller 40 estimates the execution time Tx using the execution time calculation map. Thus, the controller 40 estimates the execution time Tx based on the q-axis current obtained at the point in time when the stop command for the motor 16 is received from the air conditioning ECU 41.

Then, in step S13, upon receipt of the stop command for the motor 16 from the air conditioning ECU 41, the controller 40 executes the first speed reduction control to reduce the rotation speed of the motor 16 through position sensorless control. Subsequently, the controller 40 determines in step S14 whether the rotation speed of the motor 16 is reduced to the predetermined rotation speed. When determining in step S14 that the rotation speed of the motor 16 is not reduced to the predetermined rotation speed, the controller 40 returns to step S13.

When determining in step S14 that the rotation speed of the motor 16 is reduced to the predetermined rotation speed, the controller 40 proceeds to step S15. In step S15, the controller 40 switches the first speed reduction control to the second speed reduction control. Then, in step S16, the controller 40 executes the second speed reduction control to reduce the rotation speed of the motor 16 to zero through forced synchronization control.

Next, the controller 40 determines in step S17 whether the rotation speed of the motor 16 is zero. When determining in step S17 that the rotation speed of the motor 16 is not zero, the controller 40 returns to step S16. When determining in step S17 that the rotation speed of the motor 16 is zero, the controller 40 proceeds to step S18. In step S18, the controller 40 switches the second speed reduction control to the braking control and executes the braking control.

Subsequently, the controller 40 determines in step S19 whether the execution time Tx has elapsed. When determining in step S19 that the execution time Tx has not elapsed, the controller 40 returns to step S18. When determining in step S19 that the execution time Tx has elapsed, the controller 40 proceeds to step S20. In step S20, the controller 40 terminates the braking control.

As shown in FIG. 3, when the execution time Tx elapses, the refrigerant that remains in the compression chamber 22 is sufficiently drawn into the motor housing member 13. Thus, the pressure in the compression chamber 22 is substantially equal to the suction pressure. Accordingly, when the braking control is terminated, the backward rotation of the rotor 25 that would result from the expansion of the refrigerant does not occur. Hence, the rotation of the rotor 25 is forcibly stopped. This prevents the backward rotation of the rotor 25 that would result from the expansion of the refrigerant remaining in the compression chamber 22.

### Advantages of Embodiment

The above embodiment provides the following advantages.

(1) In the motor-driven compressor 10, for example, as the discharge pressure increases, the pressure in the compression chamber 22 increases. Further, as the differential pressure between the pressure in the compression chamber 22 and the suction pressure increases, the backward rotation of the rotor 25 that would result from the expansion of the refrigerant remaining in the compression chamber 22 is more likely to occur. To solve this problem, the controller 40 uses the differential pressure between the discharge pressure and the suction pressure to estimate the execution time Tx of the braking control, which is needed to fix the position θ of the rotor 25 at the specific angle. Then, the controller 40 executes the braking control for the estimated execution time Tx. Accordingly, the controller 40 will not unnecessarily continue to execute the braking control. This efficiently prevents the rotor 25 from rotating backwards.

(2) For example, when direct-current exciting energization is executed as the braking control, the power consumption increases as the period of time of the direct-current exciting energization increases. Thus, the power consumption will unnecessarily increase if direct-current exciting energization is executed for a period of time that is longer than the execution time of the braking control, which is needed to fix the position θ of the rotor 25 at the specific angle. To solve this problem, the controller 40 executes direct-current exciting energization as the braking control within the estimated execution time Tx. Accordingly, even if direct-current exciting energization is executed as the braking control, the power consumption will not unnecessarily increase. This efficiently prevents the rotor 25 from rotating backwards, while also reducing the power consumption.

(3) The q-axis current flowing through the motor 16 is associated with the differential pressure between the discharge pressure and the suction pressure. Thus, the controller 40 uses the q-axis current to estimate the execution time Tx of the braking control, which is needed to fix the position θ of the rotor 25 at the specific angle. Accordingly, there is no need for a pressure sensor that detects the suction pressure and the discharge pressure. This efficiently prevents the rotor 25 from rotating backwards, while also achieving a cost reduction.

(4) The value of the q-axis current obtained until the stop command for the motor 16 is received from the air conditioning ECU 41 is, for example, more stable than the value of the q-axis current obtained at the point in time when the rotation speed of the motor 16 becomes zero. Thus, the controller 40 estimates the execution time Tx of the braking control, which is needed to fix the position θ of the rotor 25 at the specific angle, based on the q-axis current obtained at the point in time when the stop command for the motor 16 is received from the air conditioning ECU 41. This allows for accurate estimation of the execution time Tx of the braking control, which is needed to fix the position θ of the rotor 25 at the specific angle.

(5) The controller 40 executes the braking control such that the position θ of the rotor 25 is fixed at the specific angle at the point in time when the rotation speed of the motor 16 becomes zero. For example, if the controller 40 executes the braking control while the rotor 25 is rotating idly, an excessive amount of induced current from the motor 16 produced by the idle rotation of the rotor 25 would flow into the inverter 30. The above configuration avoids such a problem. Accordingly, the switching elements Qu1, Qu2, Qv1, Qv2, Qw1, Qw2 are prevented from being adversely affected.

(6) The controller 40 reduces the rotation speed of the motor 16 to zero through forced synchronization control. This configuration ensures that the rotation speed of the motor 16 is reduced to zero through forced synchronization control in a stable manner. This readily avoids situations in which the controller 40 executes the braking control while the rotor 25 is rotating idly.

(7) The controller 40 executes the braking control for the estimated execution time Tx. Accordingly, the controller 40 will not unnecessarily continue to execute the braking control. This allows the motor 16 to be quickly restarted.

Modifications

The above embodiment may be modified as follows. The above embodiment and the following modifications can be combined as long as the combined modifications remain technically consistent with each other.

In the embodiment, the controller 40 may execute at least zero vector energization as the braking control. For example, zero vector energization turns on the upper arm switching elements Qu1, Qv1, Qw1 in their respective phases and turns off the lower arm switching elements Qu2, Qv2, Qw2 in their respective phases. In short, zero vector energization turns on all the switching elements of one of the upper arm switching elements Qu1, Qv1, Qw1 or the lower arm switching elements Qu2, Qv2, Qw2 and turns off all the switching elements of the other one of the upper arm switching elements Qu1, Qv1, Qw1 or the lower arm switching elements Qu2, Qv2, Qw2. Thus, the position θ of the rotor 25 is fixed at the specific angle. The controller 40 may switch direct-current exciting energization to zero vector energization after executing direct-current exciting energization for a predetermined time within the estimated execution time Tx. Accordingly, the controller 40 executes at least direct-current exciting energization as the braking control.

Unlike direct-current exciting energization, the execution of zero vector energization as the braking control consumes no power. However, as compared to direct-current exciting energization, zero vector energization requires a longer time to stop the rotation of the rotor 25. To solve this problem, the controller 40 switches direct-current exciting energization to zero vector energization after executing direct-current exciting energization for the predetermined time within the estimated execution time Tx. Accordingly, as compared to when only zero vector energization is executed as the braking control, the time required to stop the rotation of the rotor 25 will not be longer. Further, as compared to when only direct-current exciting energization is executed as the braking control, the power consumption is reduced.

In the embodiment, the controller 40 may estimate the execution time Tx based on the variations in the current flowing from the inverter 30 into the motor 16 per rotation of the motor 16 that occur when the motor 16 is driven. The variations in the current flowing from the inverter 30 into the motor 16 per rotation of the motor 16 that occur when the motor 16 is driven is associated with the differential pressure between the discharge pressure and the suction pressure. Thus, the controller 40 estimates the execution time Tx of the braking control, which is needed to fix the position θ of the rotor 25 at the specific angle, based on the variations in the current flowing from the inverter 30 into the motor 16 per rotation of the motor 16 that occur when the motor 16 is driven. Accordingly, there is no need for a pressure sensor that detects the suction pressure and the discharge pressure. This efficiently prevents the rotor 25 from rotating backwards, while also achieving a cost reduction.

In the embodiment, the controller 40 may estimate the execution time Tx based on the variations in the rotation speed of the motor 16 that occur when the motor 16 is driven. The variations in the rotation speed of the motor 16 that occur when the motor 16 is driven is associated with the differential pressure between the discharge pressure and the suction pressure. Thus, the controller 40 estimates the execution time Tx of the braking control, which is needed to fix the position θ of the rotor 25 at the specific angle, based on the variations in the rotation speed of the motor 16 that occur when the motor 16 is driven. Accordingly, there is no need for a pressure sensor that detects the suction pressure and the discharge pressure. This efficiently prevents the rotor 25 from rotating backwards, while also achieving a cost reduction.

In the embodiment, the controller 40 may estimate the execution time Tx by multiplying the two types of variations (i.e., the variations in the current flowing from the inverter 30 into the motor 16 per rotation of the motor 16 that occur when the motor 16 is driven and the variations in the rotation speed of the motor 16 that occur when the motor 16 is driven) by each other and by further multiplying that value by a coefficient. Alternatively, the controller 40 may estimate the execution time Tx based on the average value of the two types of variations. As another option, the controller 40 may estimate the execution time Tx by using the larger one of the two types of variations.

In the embodiment, direct-current exciting energization may energize, for example, the two upper arm switching elements Qu1, Qv1 and the lower arm switching element Qv2. In short, direct-current exciting energization only needs to turn on at least one of the upper arm switching elements Qu1, Qv1, Qw1 and at least one of the lower arm switching elements Qu2, Qv2, Qw2.

In the embodiment, the controller 40 does not have to execute direct-current exciting energization as the braking control. Instead, the controller 40 may execute only zero vector energization as the braking control.

In the embodiment, for example, the controller 40 may estimate the execution time Tx of the braking control, which is needed to fix the position θ of the rotor 25 at the specific angle, based on the q-axis current obtained at the point in time when the rotation speed of the motor 16 becomes zero. In short, the q-axis current used to estimate the execution time Tx is not limited to the q-axis current obtained at the point in time when the stop command for the motor 16 is received from the air conditioning ECU 41.

In the embodiment, the controller 40 does not have to reduce the rotation speed of the motor 16 to zero through forced synchronization control. The controller 40 may execute the braking control at the point in time when the rotation speed of the motor 16 becomes zero after the rotation speed of the motor 16 gradually decreases due to idle rotation. In this case, the controller 40 needs to recognize that the rotation speed of the motor 16 becomes zero using a means for detecting the rotation speed of the motor 16.

In the embodiment, the controller 40 does not have to execute the braking control at the point in time when the rotation speed of the motor 16 becomes zero. For example, the controller 40 may execute the braking control at a point in time when the rotation speed of the motor 16 decreases to a predetermined rotation speed after the rotation speed of the motor 16 decreases.

In the embodiment, the controller 40 may estimate the execution time Tx based on the differential pressure between the discharge pressure and the suction pressure by, for example, obtaining the information related to the differential pressure between the discharge pressure and the suction pressure from a vehicle system.

In the embodiment, the time estimation unit of the motor-driven compressor 10 may be separate from the controller 40.

In the embodiment, the compression portion 15 does not have to be of a scroll type including the fixed scroll 20 and the orbiting scroll 21. Instead, the compression portion 15 may be of, for example, a vane type.

In the embodiment, the motor-driven compressor 10 may have, for example, a structure in which the inverter 30 is located outward from the housing 11 in the radial direction of the rotary shaft 14. In short, the compression portion 15, the motor 16, and the inverter 30 do not have to be arranged in this order in the axial direction of the rotary shaft 14.

In the embodiment, the motor-driven compressor 10 is included in the vehicle air conditioner 28. Instead, the motor-driven compressor 10 may be, for example, mounted on a fuel cell electric vehicle to compress air supplied to a fuel cell using the compression portion 15.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A motor-driven compressor, comprising:
a compression portion including a compression chamber that compresses and discharges drawn fluid;
a motor that drives the compression portion;
an inverter including a switching element that performs switching operation to drive the motor;
a controller that controls the driving of the motor, the controller being configured to receive a stop command for the motor and then execute braking control that controls the switching operation performed by the switching element such that a position of a rotor of the motor is fixed at a specific angle; and
a time estimation unit that uses a differential pressure between a discharge pressure and a suction pressure to estimate an execution time of the braking control needed to fix the position of the rotor at the specific angle,
wherein the controller is configured to execute the braking control for the execution time estimated by the time estimation unit.

2. The motor-driven compressor according to claim 1, wherein
the switching element includes upper arm switching elements and lower arm switching elements, and
the controller is configured to execute, as the braking control, at least direct-current exciting energization that energizes at least one of the upper arm switching elements and at least one of the lower arm switching elements.

3. The motor-driven compressor according to claim 2, wherein
the controller is configured to execute, as the braking control, at least zero vector energization that turns on all switching elements in one of the upper arm switching elements or the lower arm switching elements and turns off all the switching elements in the other one of the upper arm switching elements or the lower arm switching elements, and
the controller is configured to switch the direct-current exciting energization to the zero vector energization after executing the direct-current exciting energization for a predetermined time within the execution time estimated by the time estimation unit.

4. The motor-driven compressor according to claim 1, wherein
a q-axis current flowing through the motor is associated with the differential pressure, and
the time estimation unit is configured to estimate the execution time based on the q-axis current.

5. The motor-driven compressor according to claim 4, wherein the time estimation unit is configured to estimate the execution time based on the q-axis current obtained at a point in time when the stop command for the motor is received.

6. The motor-driven compressor according to claim 1, wherein
variations in current flowing from the inverter into the motor per rotation of the motor that occur when the motor is driven are associated with the differential pressure, and
the time estimation unit is configured to estimate the execution time based on the variations in the current.

7. The motor-driven compressor according to claim 1, wherein
variations in a rotation speed of the motor that occur when the motor is driven are associated with the differential pressure, and
the time estimation unit is configured to estimate the execution time based on the variations in the rotation speed.

8. The motor-driven compressor according to claim 1, wherein the controller is configured to execute the braking control at a point in time when a rotation speed of the motor becomes zero.

9. The motor-driven compressor according to claim 8, wherein the controller is configured to reduce the rotation speed of the motor to zero through forced synchronization control.
